(19) United States
(12) Patent Application Publication
(10) Pub. No.: US 2026/0039859 A1
(43) Pub. Date: Feb. 5, 2026

(54) Attention Mechanism for Compressed Multimedia Content Coding

(71) Applicant: Nokia Technologies Oy, Espoo (FI)

(72) Inventors: Jusso Korhonen, Espoo (FI); Hamed Rezazadegan Tavakoli, Espoo (FI); Goutham Rangu, Tampere (FI)

(21) Appl. No.: 19/288,110

(22) Filed: Aug. 1, 2025

Related U.S. Application Data
(60) Provisional application No. 63/678,583, filed on Aug. 2, 2024.

(51) Int. Cl. H04N 19/54; H04N 19/597

(52) U.S. Cl. CPC H04N 19/54; H04N 19/597

(57) ABSTRACT

Methods and apparatuses are described for entropy encoding and decoding of a latent tensor, which includes separating the latent tensor into segments in the spatial dimensions and in the channel dimension, each segment including at least one latent tensor element. An arrangement of the segments is processed by a neural network: the neural network includes at least one attention layer. Based on the processed segment a probability model is obtained for entropy encoding or decoding of a latent tensor element.

### TECHNICAL FIELD

Examples of embodiments herein relate generally to 3D (three-dimensional) multimedia content coding and decoding, and, more specifically, relate to compressing and decompressing multimedia content.

### BACKGROUND

A technique in 3D (three-dimensional) modeling and rendering that is becoming more prevalent involves 3D Gaussian Splatting. 3D Gaussian Splatting is a technique in computer graphics that creates 3D scenes by projecting points, or “splats”, from a point cloud onto a 3D space, using Gaussian functions for each splat. The term “splatting” is based on the sound a snowball makes as it hits and spreads across a window. This technique supports complex view-dependent visual effects and surpasses the quality of traditional point cloud rendering by producing dynamic and lifelike visualizations.

The idea behind Gaussian splatting originated in a 1991 doctorate thesis by Lee Alan Westover at the University of North Carolina at Chapel Hill. The hardware at the time could not efficiently run the algorithms, so this technique was not widely used until recently. While Gaussian splatting has benefits, this technique could also be improved.

### BRIEF SUMMARY

This section is intended to include examples and is not intended to be limiting.

In an exemplary embodiment, a method is disclosed that includes in an encoding process for multimedia content, forming vectors comprising query vectors, key vectors, and value vectors; running an attention function on the formed vectors to produce output, wherein the output is a representation of parameters of multiple Gaussian splats representing video of the multimedia content; and encoding information representing the multimedia content, the information comprising at least part of the formed vectors, and placing the information into a bitstream.

An additional exemplary embodiment includes a computer program, comprising instructions for performing the method of the previous paragraph, when the computer program is run on an apparatus. The computer program according to this paragraph, wherein the computer program is a computer program product comprising a computer-readable medium bearing the instructions embodied therein for use with the apparatus. Another example is the computer program according to this paragraph, wherein the program is directly loadable into an internal memory of the apparatus.

An exemplary apparatus includes one or more processors and one or more memories storing instructions that, when executed by the one or more processors, cause the apparatus at least to perform: in an encoding process for multimedia content, forming vectors comprising query vectors, key vectors, and value vectors; running an attention function on the formed vectors to produce output, wherein the output is a representation of parameters of multiple Gaussian splats representing video of the multimedia content; and encoding information representing the multimedia content, the information comprising at least part of the formed vectors, and placing the information into a bitstream.

An exemplary computer program product includes a computer-readable storage medium bearing instructions that, when executed by an apparatus, cause the apparatus to perform at least the following: in an encoding process for multimedia content, forming vectors comprising query vectors, key vectors, and value vectors; running an attention function on the formed vectors to produce output, wherein the output is a representation of parameters of multiple Gaussian splats representing video of the multimedia content; and encoding information representing the multimedia content, the information comprising at least part of the formed vectors, and placing the information into a bitstream.

In another exemplary embodiment, an apparatus comprises means for: in an encoding process for multimedia content, forming vectors comprising query vectors, key vectors, and value vectors; running an attention function on the formed vectors to produce output, wherein the output is a representation of parameters of multiple Gaussian splats representing video of the multimedia content; and encoding information representing the multimedia content, the information comprising at least part of the formed vectors, and placing the information into a bitstream.

In an exemplary embodiment, a method is disclosed that includes in a decoding process for multimedia content carried in a bitstream, receiving the bitstream having encoded information comprising indications of one or more of query vectors, key vectors, and value vectors; performing decoding using an attention function with a set of key vectors and value vectors on the query vectors to form an output that is a feature representation of parameters of multiple Gaussian splats; and output information, based at least on the output, that is representative of the multimedia content.

An additional exemplary embodiment includes a computer program, comprising instructions for performing the method of the previous paragraph, when the computer program is run on an apparatus. The computer program according to this paragraph, wherein the computer program is a computer program product comprising a computer-readable medium bearing the instructions embodied therein for use with the apparatus. Another example is the computer program according to this paragraph, wherein the program is directly loadable into an internal memory of the apparatus.

An exemplary apparatus includes one or more processors and one or more memories storing instructions that, when executed by the one or more processors, cause the apparatus at least to perform: in a decoding process for multimedia content carried in a bitstream, receiving the bitstream having encoded information comprising indications of one or more of query vectors, key vectors, and value vectors; performing decoding using an attention function with a set of key vectors and value vectors on the query vectors to form an output that is a feature representation of parameters of multiple Gaussian splats; and output information, based at least on the output, that is representative of the multimedia content.

An exemplary computer program product includes a computer-readable storage medium bearing instructions that, when executed by an apparatus, cause the apparatus to perform at least the following: in a decoding process for multimedia content carried in a bitstream, receiving the bitstream having encoded information comprising indications of one or more of query vectors, key vectors, and value vectors; performing decoding using an attention function with a set of key vectors and value vectors on the query vectors to form an output that is a feature representation of parameters of multiple Gaussian splats; and output information, based at least on the output, that is representative of the multimedia content.

In another exemplary embodiment, an apparatus comprises means for: in a decoding process for multimedia content carried in a bitstream, receiving the bitstream having encoded information comprising indications of one or more of query vectors, key vectors, and value vectors; performing decoding using an attention function with a set of key vectors and value vectors on the query vectors to form an output that is a feature representation of parameters of multiple Gaussian splats; and output information, based at least on the output, that is representative of the multimedia content.

### BRIEF DESCRIPTION OF THE DRAWINGS

The accompanying drawings use reference numerals, where the same reference numerals may be used to refer to like parts throughout, but parts having the same reference numeral can differ in operation and components. In the attached drawings:

FIG. 1 is a block diagram illustrating a system in accordance with an example;

FIG. 2 is a block diagram of a system for performing Gaussian splatting;

FIG. 3 demonstrates system for a proposed attention mechanism and the relation between query, key and value vectors for Gaussian representations;

FIG. 3A illustrates a block diagram for encoding using the system and attention mechanism of FIG. 3;

FIG. 3B illustrates a block diagram for decoding based on the encoding performed by FIG. 3A;

FIG. 3C illustrates a flow diagram of an encoding process performed by an encoder for the system of FIG. 3A;

FIG. 3D illustrates a flow diagram of a decoding process performed by a decoder for the system of FIG. 3B;

FIG. 4 is an example of a block diagram of an apparatus suitable for implementing any of the encoders or decoders described herein;

FIG. 5 is a plot for comparison between baseline and examples herein;

FIG. 6 illustrates a plot showing model size of exemplary methods is bout 4× smaller than the baseline (18.5 MB vs. 74.5 MB); and

FIG. 7 illustrates a plot showing frames per second (fps) between baseline and examples herein.

### DETAILED DESCRIPTION OF THE DRAWINGS

Abbreviations that may be found in the specification and/or the drawing figures are defined below, at the end of the detailed description section.

The word “exemplary” is used herein to mean “serving as an example, instance, or illustration.” Any embodiment described herein as “exemplary” is not necessarily to be construed as preferred or advantageous over other embodiments. All of the embodiments described in this Detailed Description are exemplary embodiments provided to enable persons skilled in the art to make or use the examples.

When more than one drawing reference numeral, word, or acronym is used within this description with “/”, and in general as used within this description, the “/” may be interpreted as “or”, “and”, or “both”. As used herein, “at least one of the following: <a list of two or more elements>” and “at least one of <a list of two or more elements>” and similar wording, where the list of two or more elements are joined by “and” or “or,” mean at least any one of the elements, or at least any two or more of the elements, or at least all the elements.

As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

It is noted that capital and lowercase words or phrases are considered to be the same herein. For instance, the words Slice and slice are the same, as are the phrases Network Repository Function and network repository function.

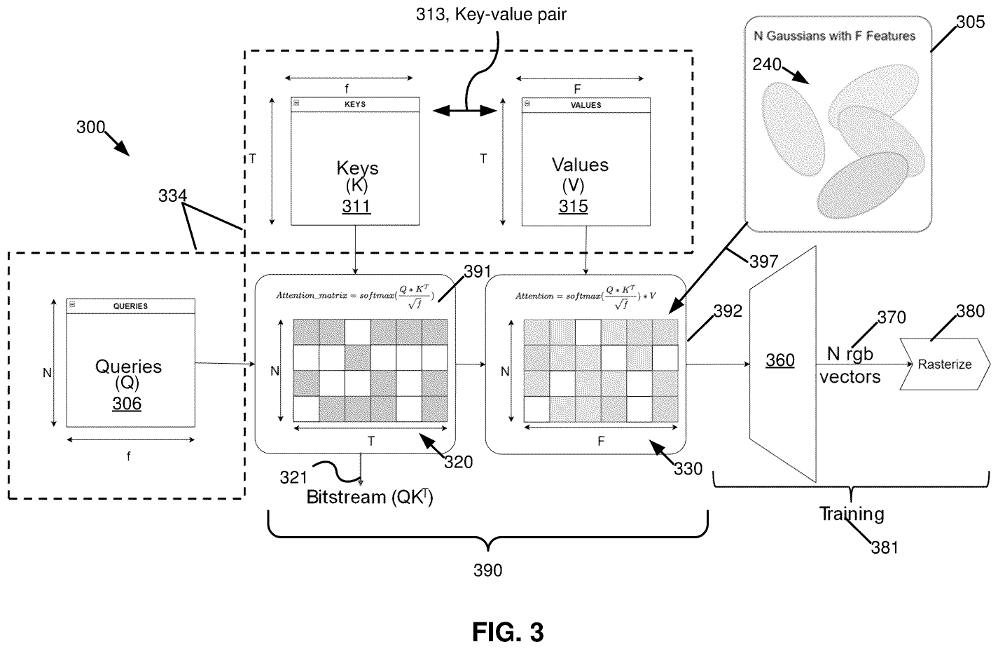

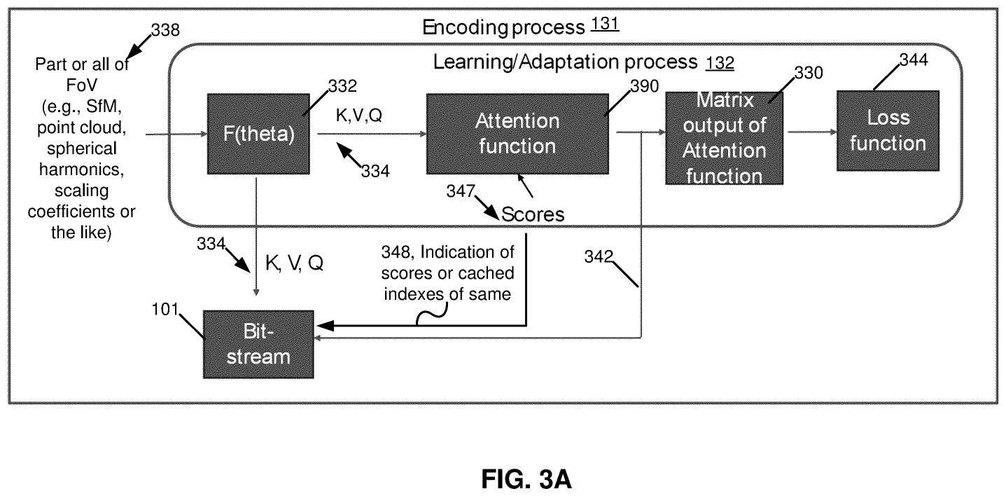

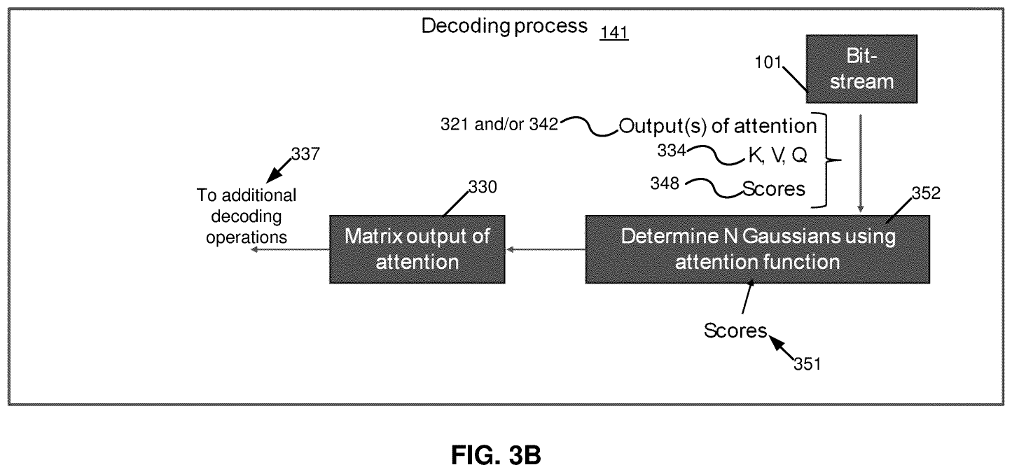

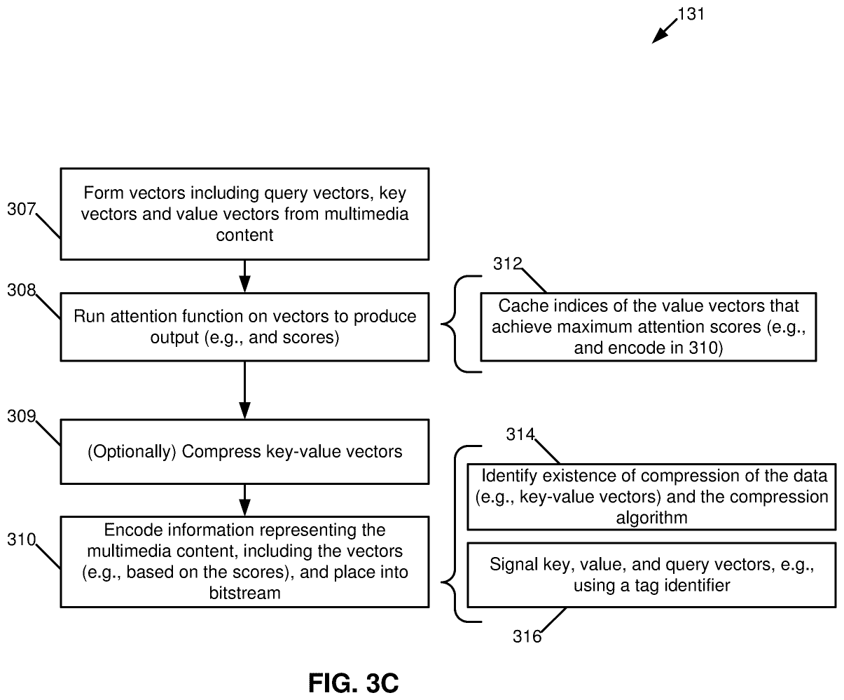

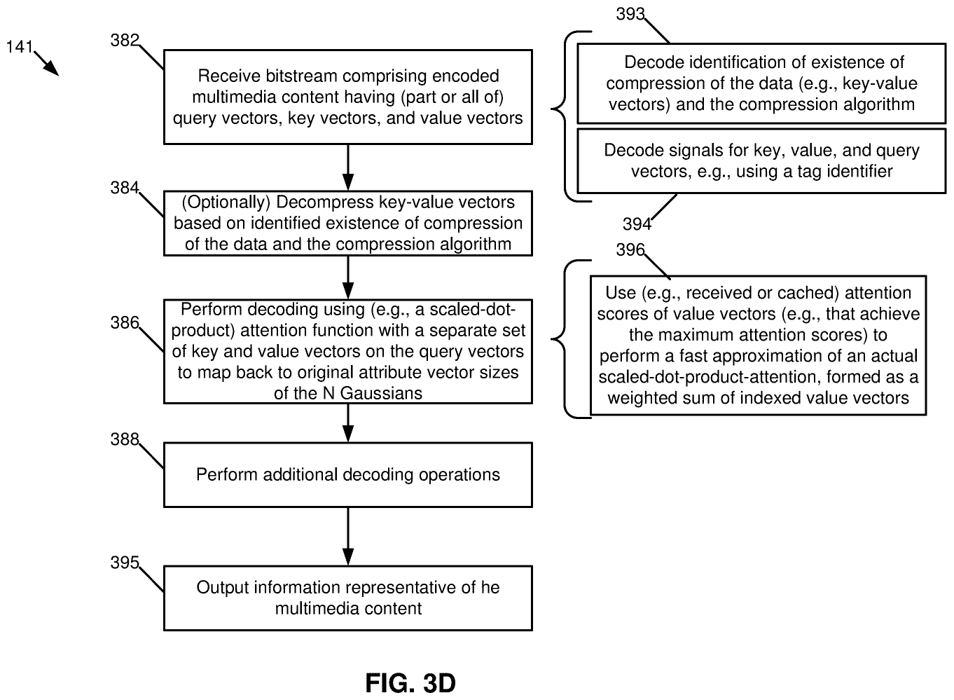

Any flow diagram (such as FIGS. 3, 3A, 3B, and 3C) or signaling diagram herein is considered to be a logic flow diagram, and illustrates the operation of an exemplary method, results of execution of computer program instructions embodied on a computer readable memory, and/or functions performed by logic implemented in circuitry. For methods, flow diagrams, and signaling diagrams, the orders of method steps, blocks in the flow, or signaling are not critical and instead are examples.

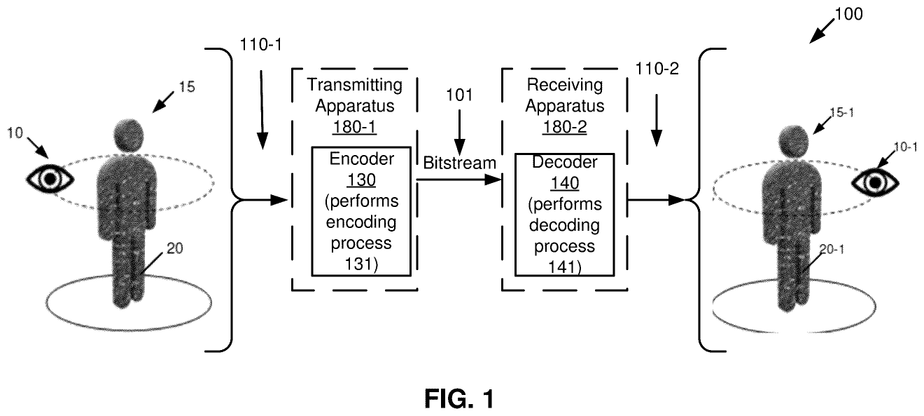

Technical context is now provided for technical areas related to the understanding of the examples. One technical area is a system that is applicable to the examples. Referring to FIG. 1, this figure is a block diagram illustrating a system 100 in accordance with an example. In the example, the encoder 130 is used to encode input multimedia content (e.g., including video) 110-1 from the scene 15, and the encoder 130 is implemented in a transmitting apparatus 180-1. While multimedia content typically includes video, there are other options such as point clouds, LiDAR (light detection and ranging, or laser imaging, detection, and ranging), and other formats with or without video. There is a capture of input video at a viewpoint 10 of a scene 15, which includes a human being 20. There could also be capture of audio for the scene 15. While there is one viewpoint 10 that is shown, multiple viewpoints may be used. The encoder 130 produces a bitstream 101, using the encoding process 131 on the input multimedia content 110-1, that is received by the receiving apparatus 180-2. The receiving apparatus 180-2 implements a decoder 140, which performs a decoding process 141. The decoder 140, using the decoding process 141 on the multimedia content carried in the bitstream 101, forms the output multimedia content 110-2 (as a representation of the input multimedia content 110-1) for the scene 15-1, and the receiving apparatus 180-2 would present this to the user, e.g., via a smartphone, television, or projector among many other options. The scene 15-1 has a viewpoint 10-1 and contains representations of at least a human being 20-1. The encoder 130 and decoder 140 may be applied to multiple coding standards.

One such standard is Versatile Video Coding (VVC), which is a new international video coding standard. Enhanced Compression Model (ECM) is built on top of VVC and is potentially a future video coding standard that is currently under the development sponsored by JVET. Both VVC and ECM are block-based video coding standards, where an input picture is divided into CTUs (coding tree units), and each CTU may be further split into CUs (coding units). A CU (as one type of block) is coded in either inter-coding mode or intra-coding mode. If the block is in inter-coding mode, the encoder 130 searches for a temporal prediction block in reference picture(s), may signal the decoder 140 how to find the same prediction block in reference picture(s) at the decoder end. If the block is in intra coding mode, the encoder 130 constructs a spatial prediction block from the current picture, and may signal the decoder 140 how to form the same spatial prediction block from the current picture at the decoder end.

At the encoder 130 end, the residual block between a current CU and its prediction block is transformed and quantized. The quantized transform coefficients are entropy coded. The decoder 140, on the other hand, performs inverse operations, such as, entropy decoding, dequantization and inverse transform, to reconstruct the residual block, and reconstructs the CU (or block) by adding the reconstructed residual block to the prediction block.

Another technical area concerns compression. Compressing multimedia content, such as images, videos and 3D scenes, using implicit neural architectures is an active research area. Obtaining a representation, that is both compressed and efficient to train and run inference, is challenging. Such architectures have significant application in neural video coding, implicit neural representations, and 3D scene capture methods such as 3D Gaussian splatting, neural radiance fields or compression of point clouds.

A 3D Gaussian splatting (3DGS) method was first introduced by Kerbl et al. in their 2023 paper (Bernhard Kerbl, Georgios Kopanas, Thomas Leimkühler, and George Drettakis, “3D Gaussian Splatting for Real-Time Radiance Field Rendering”, ACM Trans. Graph. 42, 4, Article 1 (August 2023), 14 pages. doi.org/10.1145/3592433). In the paper, they present the “vanilla model”, which stores spherical harmonic coefficients per Gaussian to represent color information. Although the model achieves high-quality and is fast to render, the model size is shown to be orders of magnitude larger than the competing neural radiance field models. Sec Table 1:500-800MB (3DGS) vs. 8-50MB (Mip-NeRF-360, Instant-NGP), where the 3DGS is 523 MB in memory, while the Mip-NeRF-360 is 8.6Mb and Instant-NGP is 13 MB. Multiple subsequent research papers have targeted specifically this model size problem of 3DGS.

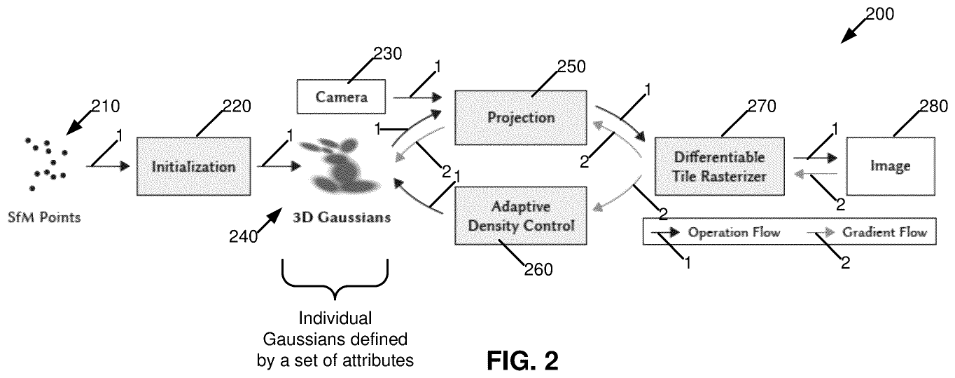

Referring to FIG. 2, this is a block diagram of a system for performing Gaussian splatting and is a modified version of FIG. 2 from Kerbl et al. The system 200 initializes via initialization block 220 the set of 3D Gaussians 240 with the sparse point cloud produced as part of the Structure-from-Motion (SfM) process. See the spart point cloud shown as SfM points 210. The 3D Gaussians 240 (which are the splats) have a number of attributes (also referred to as features) including color, shape, 3D position, opacity a, anisotropic covariance, and/or spherical harmonic (SH) coefficients. The directional appearance component (color) of the radiance field is represented via spherical harmonics (SH), following standard practice [Fridovich-Keil and Yu et al. 2022; Müller et al.]. This definition is from Bernhard Kerbl, Georgios Kopanas, Thomas Leimkühler, and George Drettakis, “3D Gaussian Splatting for Real-Time Radiance Field Rendering”, ACM Trans. Graph. 42, 4, Article 1 (August 2023), 14 pages. The camera 230 produces 3D images supplied to the projection 250, which projects 3D to 2D. The differential tile rasterizer 270 rasterizes the 2D images from the projection to create images 280. The operation flow 1 has been described.

The gradient flow 2 is used in part to modify the 3D Gaussians 240, where the image 280 has gradient flow 2 to the differentiable tile rasterizer 270, which has gradient flow 2 to the projection 250 and adaptive density control 260, both of which have gradient flow 2 to the 3D Gaussians 240. The adaptive density control 260 helps to create high-quality representations for captured scenes as represented by the 2D images 280. The system 200 provides optimization that is based on successive iterations of rendering and comparing the resulting image 280 to the training views in a captured dataset.

Compressing implicit neural representation (INR) approaches and radiance field related techniques are difficult and challenging. There is a high amount of redundancy in the stored information, even when a latent vector is used to represent the visual information, e.g., latent vector of video encoders, the color of a Gaussian in a 3D Gaussian splat, and the like. In approaches that rely on Gaussian representation for content representation, e.g., 3D Gaussian splats or 2D Gaussians for video compression. A large proportion of the latent representation and Gaussians are likely to end up storing highly similar latent feature vectors that decode to a highly similar spherical representation (e.g., matte black). The latent feature representation, thus, must be large enough to represent complex information. The complex information is often represented with a neural network (i.e., weights of neural network).

The examples herein tackle at least the challenge of information compression in implicit neural representations when a Gaussian-based information representation is involved for multimedia content generation, including 2D and 3D. In contrast to the above, for instance, a simple yet effective approach is proposed for compression of Gaussian splats. Proposed approaches are extensible to other implicit neural representation schemes, neural video coding approaches, and radiance fields for 2D and 3D multimedia content compression. One proposed method is orthogonal to the above but could co-exist with them to further bring gain in compression of INR and their radiance field related techniques.

As an overview, an attention mechanism is proposed for compressed and efficient multimedia content coding and the mechanism is implemented for the compression of 3D Gaussian splatting. 3D Gaussian splatting is a state-of-the-art approach for creating a novel-view-synthesis model from a set of 2D images of a scene. Splatting achieves this by creating and tuning a large set of 3D Gaussians 240, which store a set of attributes per Gaussian like color, shape, or the like. As previously described, these 3D Gaussians can be rasterized onto an image plane according to their attributes, and one can optimize the attribute values to recreate the 2D training images. A rasterization may then be performed (e.g., by differentiable tile rasterizer 270) of the optimized set of 3D Gaussians from novel viewpoints to achieve novel-view-synthesis. The achieved quality and rendering speed of the novel-views with the 3D Gaussian splatting represents state-of-the-art. Model size is, however, a common problem with all neural-based multimedia content coding techniques, and model size is shared also by the 3D Gaussian splatting. To represent a complex scene in high-quality, a massive number of parameters and data points may be required, e.g., for 3D Gaussian splatting techniques millions of Gaussians may be required, amounting to possibly gigabytes of storage.

In an example herein, the latent feature vector per gaussian (e.g., the vector containing the spherical harmonic coefficients as in the original implementation) is replaced with a small query vector per Gaussian, and the decoding process (e.g., back to the spherical harmonic coefficients) is a scaled-dot-product-attention with a separate set of key and value vectors. The query vector and the key vectors can be an order of magnitude smaller than the latent vector, because they only have to perform routing. Redundancy is reduced because multiple gaussians can route to one value vector, and thus the model size is reduced.

Experiment results (described below) demonstrate such an attention mechanism reducing the 3D gaussian splatting model size by 4× (four times) when compared to the baseline way of storing spherical harmonic coefficients per gaussian, while retaining a similar level of visual quality. A caching mechanism of the most impactful value vector indices is additionally proposed, in exemplary embodiments, for fast rendering during evaluation time.

It is worth noting that the achieved 4× compression does not involve further compression of key, value and query vectors such as quantization and entropy coding. It is also to gain further compression employing ISO/IEC 15398-17, ISO/IEC 15938-17:2024, Part 17: Compression of neural networks for multimedia content description and analysis, published 2024-01.

Now that an overview has been provided, more details are provided. In examples, the latent feature vector (stored per gaussian) is replaced with a small query vector, and the decoding process (e.g., back to the original attribute size) is a scaled-dot-product-attention with a separate set of key and value vectors. The query (and the key) vectors can be tiny as they only have to learn to do the routing of the gaussian to access correct latent information (stored in the value vectors).

FIG. 3 demonstrates a proposed system 300 implementing an attention mechanism 390 (also referred to as an attention function) and the relation between queries 306, keys 311, and values 315 for Gaussian representations. It is noted that the queries 306, keys 311, and values 315 are (e.g., 2D) vectors, but for ease of reference, the term “vector” may not be used below.

Reference 390 indicates the attention function:

$$Attention ( Q , K , V ) = softmax ( \frac{{QK}^{T}}{\sqrt{f}} ) V ,$$

where:
Q∈ [symbol] ^{N×f} represents the queries of N Gaussians 240;
K∈ [symbol] ^{T×f} is the matrix of keys;
V∈ [symbol] ^{T×F} is the matrix of values;
f is the dimension of the key vectors (and query vectors); and
F is the dimension of the feature vectors.

For clarity, the T in QK^{T} means “transpose”. Also, the dimensions of Q are N×f, the dimensions of K are T×f, so the dimensions of QK^{T} are N×T. The dimension of V are T×F, so the dimensions of QK^{T}V are N×F. It is noted that both N and F are assumed to be greater than one and typically in the tens to hundreds.

An attention function 390 can be described as mapping a query and a set of key-value pairs to an output 330, where the queries 306, keys 311, values 315, and output 330 are all vectors. The output 330 is computed as a weighted sum of the values 315, where the weight assigned to each value 315 is computed by a compatibility function of the query 306 with the corresponding key 311. The input includes the queries 306 and keys 311 of dimension f, and values of dimension F. The dot products of the query with all keys are computed, and this result is divided by \sqrt{f}, and a softmax function is applied to obtain the weights on the values. Another way to describe an attention function is this is similar to decomposition, and is learned through a process by neural network(s).

In this example, the queries 306, keys 311, and values 315 are output 334 of a neural network (NN) illustrated in FIG. 3A (described below) as F (theta) function 332, which forms the vectors of the queries 306, keys 311, and values 315. In FIG. 3, the attention function 390 is illustrated as being broken into two parts 391 and 392. Part 391 performs the

$$softmax ( \frac{{QK}^{T}}{\sqrt{f}} )$$

part of the attention function 390 and takes as inputs the queries 306 and the keys 311, and produces output 320. One option is to place the QK^{T} (e.g., or the softmax (QK^{T}/\sqrt{f}) or the scaled version (QK^{T}/\sqrt{f})) into the bitstream as output 321. The part 392 performs the “rest” of the attention function 390 by multiplying the output 320 by the values 315 to create output 330. Output 330 is a feature representation of parameters of N Gaussians 240. The N Gaussians 240 with F features are illustrated by block 305, e.g., an N×F vector describing the N Gaussians 240 and their corresponding F features. More specifically, the output 330 is representation of the features of the N Gaussians, where the N Gaussian (splats) represent video in the multimedia content 110-1. Reference 397 is used to illustrate this representation aspect (i.e., the output 330 is not directly equal to the N×F vector of Gaussians and corresponding features in block 305, but are representative of this information).

The training part 381 illustrates that training can be performed. The training involves the output 330 being passed through block 360, which is a neural network that outputs N rgb vectors 370, and the resultant N rgb vectors 370 can be rasterized 380 for comparison with original multimedia 110-1 (not shown in this figure), and this can be fed back, e.g., to improve the queries 306, keys 311, and values 315.

Some of the description herein refers to key-value pairs. One example key-value pair 313 is illustrated, and this corresponds to the first row of each of the key vectors 311 and the value vectors 315. In vectors of keys 311 and values 315, the dimension T is the same, but the dimensions of f and F may not be the same. Consider the example of a dictionary. If a key is a word, then value is information about the word. These create a key-value pair 313.

The number of value vectors 315 are independent of the number of Gaussians 240 used to represent the scene. The redundancy is reduced because multiple Gaussians can route to one value vector, and the model size is decreased.

And because the number of value vectors is independent of the number of Gaussians, these value vectors can be chosen to be high dimensional vectors, in order of 102: In such a scenario, one can, for example, use a simple linear layer to decode them into an RGB color.

Block diagram of an encoding process 131 that uses the system 300 and that further explains the process is illustrated in FIG. 3A. The encoding process 131 further includes a learning/adaptation process 132. The input 338 may be part or all of a field of view (FoV) (e.g., of a camera viewing a scene corresponding to the multimedia content) for multimedia content 110-1, such as being expressed as SfM, point cloud, spherical harmonics, scaling coefficients, or the like, which can be part of representation of N Gaussians. The F (theta) function 332 is assumed to be a neural network (NN), which forms the query vectors (Q) 306, the key (K) vectors 311, and value (V) vectors 315 as output 334, which is applied to the attention function 390 and may be output to the bitstream 101. Note that the version of the output 334 that is placed into the bitstream 101 could be compressed, encoded, or the like. The attention function 390 operates on the output 334 and produces matrix output 330 of the attention function. The attention function 390 creates scores 347, and indication 348 of some or all of the scores 347 (or cached indexes of the same) can be placed into the bitstream 101 (e.g., after being compressed, encoded, or the like). The matrix output 330 (or a part of it, meaning less than all of it) can be placed into the bitstream 101, as indicated by reference 342. Concerning what could be signaled, the signaling in 334 could contain at least (indications of) one of the related information, e.g., query vectors, key vectors, and/or value vectors. It is envisioned that it is possible that just one of these information would be signaled. For 348, (indications of) scores or indexes or both could be signaled, and some examples only signal part of the scores/indexes (e.g., the scores/indexes meeting some threshold indicating they have maximum attention scores). For the matrix output 330 in 342, (indication of) parts or all of this could be signaled.

The loss function 344 is a learning function (or adaptation function after learning has been performed) and may perform comparisons known to those skilled in this area, and is used during initial training and adaptation after training.

In terms of what is or may be placed into the bitstream 101 and sent by the encoder (and therefore received by the decoder), some of Q, K, or V (or parts of these) could be pre-learned matrices, and therefore would not be sent. In an example, the information that is encoded comprises one or more of the query vectors, key vectors, and value vectors, but not all three of the query vectors, key vectors, and value vectors. This would reduce what is sent. The bitstream may contain the following:
1) (parts or all of) attention-related data, i.e., Q, K, V matrices.
2) indication of the size of individual matrices;
3) an identifier indicating which matrices are included in the bitstream; and/or
4) an identifier indicating if caching is used for efficient multiplication.
5) if the caching identifier is used, a list of indices and the relevant updated values; and/or
6) an identifier to indicate if the matrices are compressed, e.g., using the NNC or ISO/IEC 15938-17.

Turning to FIG. 3B, this figure illustrates a block diagram for decoding based on the encoding performed by FIG. 3A. A decoding process 141 is illustrated in FIG. 3B, and the bitstream 101 contains at least the K, V, Q vectors from output 334. Other options include the output(s) 321 and/or 342 of the attention function 390, and additionally or alternatively the indication 348 of some or all of the scores 347 (or cached indexes of the same). In block 352, the N Gaussians 240 are determined using the attention function 390 with the K, V, and Q as input and the matrix output 330 being the representations of the features of the N Gaussians 240. From the (e.g., matrix) output 330, it is a direct conversion to N Gaussians to use for display. In other words, output 330 is a representation of features of N Gaussians, and these features can be used to create the N Gaussians, which can then be used to form a display output. As described previously, the attention function 390 produces scores 351, which may be used as described herein. The matrix output 330 is then passed (reference 337) to additional decoding operations.

For guaranteed fast rendering during evaluation, the scaled-dot-product-attention used in the attention function 390 can be approximated by caching the indices of the value vectors that achieve the maximum attention scores 347 and 351 at both encoder and decoder (or by scores 347 sent from the encoder to the decoder and used by the decoder). Then, at the encoder, only a handful of value vectors 315 and their indices are updated and transferred to the decoder each time. In the decoder side, when the attention scores (347 or 351) of these value vectors are stored, a fast approximation of the scaled-dot-product-attention can be formed as a weighted sum of the attention scores over the indexed value vectors 315 instead of the complete matrix multiplication.

For signaled information, normally the key 311, value 315, and query 306 vectors are signaled between the encoder 130 and decoder 140. To identify this information, an identifier may be accompanied with the tensor data and the dimensional information of the tensor data such as the number of rows, columns and the row-wise and column wise information related to them. The term tensor data refers to an identifier in a high-level syntax that tells what data is to be decoded, e.g., the key values, value values, query values, and so on.

Consideration is made now also to compressed key-value vectors (see key-value pair 313 from FIG. 3). The information of key-value vectors could be further be compressed, e.g., using some dimension reduction approaches or neural network coding approaches. Such information may be compressed by ISO/IEC 15938-17 or alternative means including zip or similar nature compression algorithms. In such a case, the bitstream will include indication identifying existence of compression of the data (e.g., key-value vectors as per key-value pairs 313) and the compression algorithm. The decoding step will use a decompression step before executing the attention function.

Application to Neural Video Codecs/Gaussian case is considered now. Without the lack of generalizability, the proposed approaches could apply to 2D video coding, whenever a Gaussian representation is used to encode the 2D video. A 2D video could be represented as Gaussians, considering the spatial-temporal data or picture groups as a volume of data that could be projected into different spatial and spatial-temporal axis.

Another example is an embodiment on Application to Neural Video Codecs/Non-Gaussian case. Neural video codecs often produce a vectorial latent representation that is consuming tremendous amounts of information. The proposed attention mechanism could be one way of reducing the amount of information for such representations. That is, the attention mechanism may be pre-trained, the decoder receives a query vector that is used to from the proper value using the pre-stored key, value pairs. The key-value pairs may be periodically updated to adapt to the video content.

Turning to FIG. 3C, this figure illustrates a flow diagram of an encoding process 131 performed by an encoder 130 for the system of FIG. 3A. In block 307, the encoder forms vectors including query vectors, key vectors and value vectors from multimedia content 110-1. As described previously, the multimedia content 110-1 can include SfM and other video-related data, point clouds, or LiDAR as examples. The forming of the vectors can be performed using the function 332 (e.g., performed by a neural network) as illustrated in FIG. 3A.

In block 308, the attention function is run by the encoder 130 on vectors to produce output 330 (e.g., and scores 347 if used). Block 312 is one example of an additional embodiment, where the encoder 130 can cache indices of the value vectors that achieve maximum attention scores 347, e.g., as being above some threshold as one metric. For instance, if there are 100 value vectors, those 10 above some metric could be the value vectors that achieve maximum attention scores 347, and the indices for those 10 would be cached. These would also be encoded in block 310 if they will be sent. In block 309, the encoder 130 can optionally compress key-value vectors. The compression could be using for example the NNC approach or the ISO/IEC 15938-17, and the compression could include quantization and entropy coding on top of the current matrices or key-value vectors.

In block 310, the encoder encodes information representing the multimedia content, including the vectors (e.g., based on the scores), and places these into a bitstream 101. If block 309 is performed, then the encoder 130 identifies (see block 314) existence of compression of the data (e.g., key-value vectors) and the compression algorithm as part of the encoding the information. It is also possible to signal key, value, and query vectors, e.g., using a tag identifier. See block 316.

Referring to FIG. 3D, this figure illustrates a flow diagram of a decoding process performed by a decoder for the system of FIG. 3B. In block 382, the decoder 140 receives a bitstream 101-1 comprising encoded multimedia content having (part or all of) query vectors, key vectors, and value vectors. Additionally, the decoder 140 may decode (see block 393) identification of existence of compression of the data (e.g., key-value vectors) and the compression algorithm. In block 394, the decoder 140 may decode signals for key, value, and query vectors, e.g., using a tag identifier. In block 384, the decoder 140 may (e.g., optionally) decompress key-value vectors based on identified existence of compression of the data and the compression algorithm.

In block 386, the decoder 140 performs decoding using (e.g., a scaled-dot-product) attention function with a separate set of key and value vectors on the query vectors to map back to original attribute vector sizes of the N Gaussians. Block 396 shows another option, where (e.g., received or cached) attention scores (e.g., 348 or 351) of value vectors are used to perform a fast approximation of an actual scaled-dot-product-attention, formed as a weighted sum of indexed value vectors. In the weighted sum, the weights may be the softmax (QK^{T}/\sqrt{f}), e.g., from output 321 of FIG. 3, which are applied to V to get the weighted sum. As described previously, the indices of the value vectors that achieve the maximum attention scores 347 and 351 (based on a threshold) at both encoder and decoder (or by scores 347 sent from the encoder to the decoder and used by the decoder) may be used, along with their corresponding value vectors, to form the weighted sum. That is, the scores of value vectors used to perform the approximation of the attention function are value vectors that meet a threshold selecting these value vectors as achieving maximum attention scores out of a larger set of value vectors.

The decoder 140 in block 388 performs additional decoding operations. In block 395, the decoder 140 outputs information representative of the multimedia content (e.g., as multimedia content 110-2 of FIG. 1). This could be output directly to a display device, such as a touchscreen, television, computer monitor, projector, or the like, and, e.g., including audio equipment such as speakers, amplifiers, receivers, or the like. Since the input may correspond to part or all of a field of view corresponding to the multimedia content, the outputting information may comprise outputting information to create the part or all of the field of view. For instance, the information output for the field of view is expressed as Structure-from-Motion, a point cloud, spherical harmonics, or scaling coefficients, which represents information from the multiple Gaussian splats.

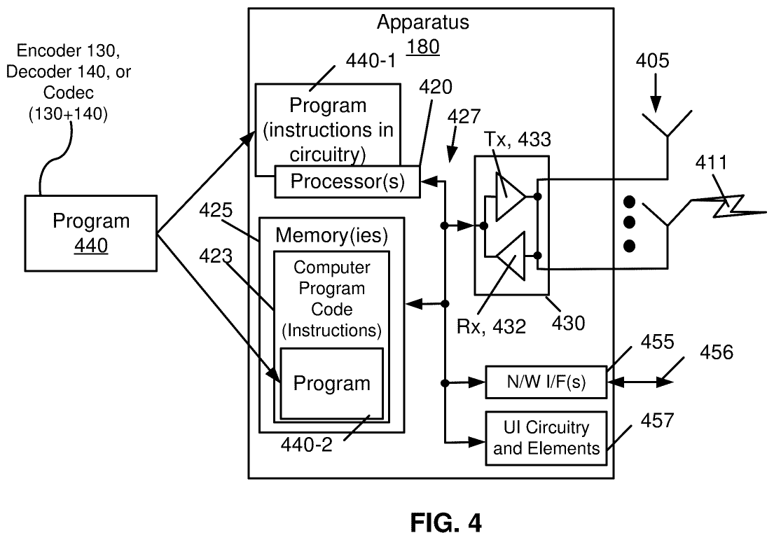

Turning to FIG. 4, this figure is an example of a block diagram of an apparatus 180 suitable for implementing any of the encoders or decoders described herein. The apparatus 180 includes circuitry comprising one or more processors 420, one or more memories 425, one or more transceivers 430, one or more network (N/W) interface(s) (I/F(s)) 455 and user interface (UI) circuitry and elements 457, interconnected through one or more buses 427. Depending on implementation, some apparatus may not have all of the circuitry. For example, an apparatus 180 might not have UI circuitry and elements 457. An apparatus may have additional circuitry, not described here. FIG. 4 is presented merely as an example.

Each of the one or more transceivers 430 includes a receiver, Rx, 432 and a transmitter, Tx, 433. The one or more buses 427 may be address, data, and/or control buses, and may include any interconnection mechanism, such as a series of lines on a motherboard or integrated circuit, fiber optics or other optical communication equipment, and the like. The one or more transceivers 430 are connected to one or more antennas 405, and may communicate using wireless link 411, which could implement any number of wireless communication interfaces such as Wi-Fi, cellular, or satellite.

The one or more memories 425 include computer program code 423. The apparatus 180 includes a program 440, comprising one of or both parts 440-1 and/or 440-2. The program 440 may implement an encoder 130, a decoder 140, or a codec (130 +140), which implements both encoding and decoding. The program itself may be implemented in a number of ways. The program 440 may be implemented in circuitry as program 440-1, such as being implemented as part of the one or more processors 420, and contains instructions implemented in circuitry. The program 440-1 may be implemented also as an integrated circuit or through other circuitry such as a programmable gate array. In another example, the program 440 may be implemented as program 440-2, which is implemented as computer program code (having corresponding instructions) 423 and is executed by the one or more processors 420. For instance, the one or more memories 425 store instructions that, when executed by the one or more processors 420, cause the apparatus 180 to perform one or more of the operations as described herein.

The network interface(s) (N/W I/F(s)) 455 are wired interfaces communicating using link(s) 456, which could be fiber optic or other wired interfaces. The apparatus 180 could include only wireless transceiver(s) 430, only N/W I/Fs 455, or both wireless transceiver(s) 430 and N/W I/Fs 455.

The apparatus 180 may or may not include UI circuitry and elements 457. These could include a display such as a touchscreen, speakers, or interface elements such as for headsets. For instance, an apparatus 180 of a smartphone would typically include at least a touchscreen and speakers. The UI circuitry and elements 457 may also include circuity to communicate with external UI elements (not shown) such as displays, keyboards, mice, headsets, and the like.

The computer readable memories 425 may be of any type suitable to the local technical environment and may be implemented using any suitable data storage technology, such as semiconductor-based memory devices, flash memory, firmware, magnetic memory devices and systems, optical memory devices and systems, fixed memory and removable memory. The processor(s) 420 may be of any type suitable to the local technical environment, and may include one or more of general-purpose computers, special purpose computers, microprocessors, digital signal processors (DSPs) and processors based on a multi-core processor architecture, as non-limiting examples. The processor(s) 420 control the apparatus 180 to perform the operations as described herein. The processor(s) 420 may execute instructions, including microcode, but are not implemented solely in software.

An example of the proposed method was implemented for the compression of Gaussian-based representation of multimedia content.

The dataset and baseline are as follows. The effect on quality was measured by reporting the achieved PSNR (Peak signal-to-noise ratio) on the validation dataset after 7k iterations. As dataset, the bonsai scene was used from the Mip-NeRF-360 dataset, with the validation dataset chosen as in the original Mip-NeRF-360 paper. The baseline used was the reimplementation of the vanilla 3D gaussian splatting in Nerfstudio (docs.nerf.studio/nerfology/methods/splat.html), which is an open-source platform for developing and sharing neural radiance field models.

In the experiments, (T=256) value vectors were used of length F=64 which were then regressed to diffuse and specular color components with a linear layer. These components get summed to form the RGB color. The key and the query vectors are of length f=4.

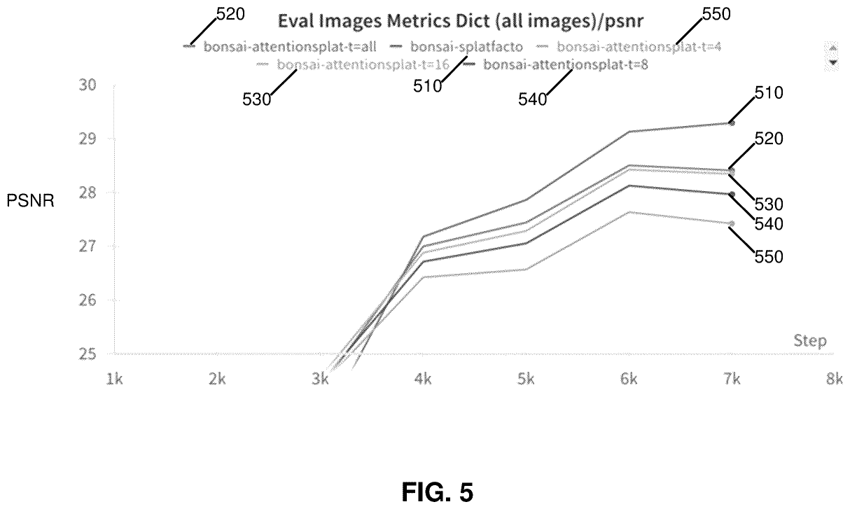

In the line plots of FIG. 5, the baseline (bonsai-splatfacto 510) and four different variants of exemplary methods are plotted: bonsai-attentionsplat-t= {4,8, 16}, 550, 540, 530, 520, respectively, where t equals the number of cached value vector indices and weights per gaussian. This is PSNR versus steps. A 0.9 dB PSNR drop is seen using the example attention mechanism compared to the baseline. The “all” indicates that all of the value vectors are used and the number is around 32. Step is the number of iterations (within the training/overfitting process) required to learn the view.

As a visual inspection, a random validation image rendering was plotted and the quality largely matches between a method used herein (attentionsplat, no caching) and the baseline (splatfacto). There are possibly some artefacts in the platform of the bonsai tree. It is expected that these could be taken care of by a more suitable regression of the value vector to the RGB, such as by using a simple linear layer.

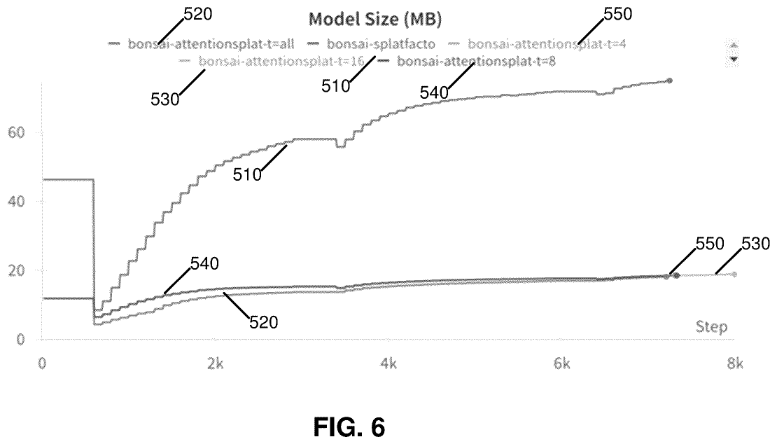

Referring to FIG. 6, this figure illustrates a plot showing model size (in MB) of an exemplary method is 4× smaller than the baseline (18.5 MB vs. 74.5 MB).

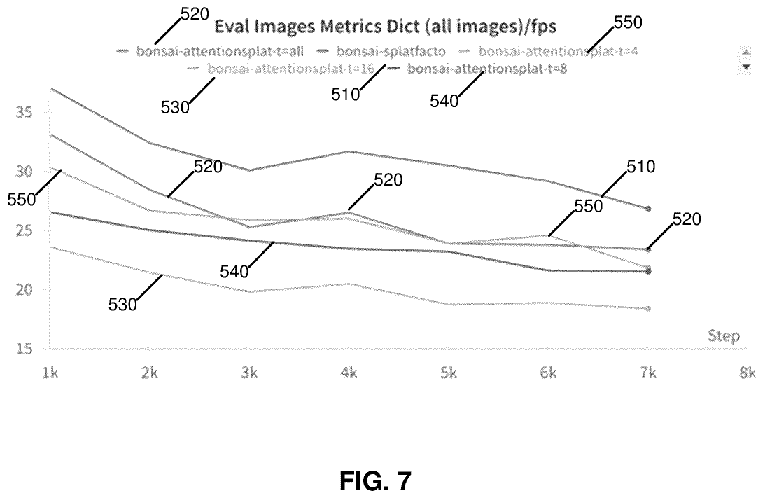

FIG. 7 illustrates a plot showing frames per second (fps) between baseline and examples herein, e.g., for all images in a dataset. In the experiments, one sees a 0.54 dB increase in PSNR when increasing t=4 to t=8, and 0.38 db when increasing from t=8 to t=16. Evaluation time for fps does not increase even from using t=4. This is likely because the PyTorch version of the scaled-dot-product-attention is so well optimized.

As a summary of the experiments, overall summary of the experiment results is that one may lose 0.9 dB in PSNR and 3-4 FPS during rendering, but the model size is compressed 4× from 75 MB to 19 MB.

Without in any way limiting the scope, interpretation, or application of the claims appearing below, a technical effect and/or advantage of one or more of the example embodiments disclosed herein is the examples are applicable to any INVR (Implicit Neural Visual Representation) or similar representation for both 2D and 3D scene representation. Another technical effect and/or advantage of one or more of the example embodiments disclosed herein is the examples can be implemented in an efficient manner.

The following are additional examples.

Example 1. A method, comprising: in an encoding process for multimedia content, forming vectors comprising query vectors, key vectors, and value vectors; running an attention function on the formed vectors to produce output, wherein the output is a representation of parameters of multiple Gaussian splats representing video of the multimedia content; and encoding information representing the multimedia content, the information comprising at least part of the formed vectors, and placing the information into a bitstream.

Example 2. The method according to example 1, further comprising: compressing key-value vectors using a compression algorithm.

Example 3. The method according to example 2, wherein the encoding information representing the multimedia content comprises: encoding indication identifying existence of compression of the key-value vectors and the corresponding compression algorithm used for the compression.

Example 4. The method according to any of examples 1 to 3, wherein encoding comprises: identifying the key vectors, value vectors, and query vectors that will be encoded using a tag identifier that accompanies tensor data describing the key vectors, value vectors, and query vectors that will be encoded and dimensional information.

Example 5. The method according to example 4, wherein the dimensional information comprises information of the tensor data including a number of rows, a number of columns and row-wise and column-wise information related to the rows and columns.

Example 6. The method according to any of examples 1 to 5, wherein the encoding process is applied to two-dimensional video coding represented by at least some of the multiple Gaussian splats.

Example 7. The method according to any of examples 1 to 6, wherein: running the attention function on the formed vectors creates scores corresponding at least to the value vectors; and the encoding information representing the multimedia content comprises encoding indication of scores for or cached indices of value vectors that achieve maximum attention scores out of a larger set of value vectors.

Example 8. The method according to any of examples 1 to 7, wherein the forming vectors comprising query vectors, key vectors, and value vectors uses input of part or all of a field of view corresponding to the multimedia content.

Example 9. The method according to example 8, wherein the input of the part or all of field of view is expressed as Structure-from-Motion, a point cloud, spherical harmonics, or scaling coefficients, which represents information from the multiple Gaussian splats.

Example 10. The method according to any of examples 1 to 9, wherein the attention function comprises:

$$Attention ( Q , K , V ) = softmax ( \frac{{QK}^{T}}{\sqrt{f}} ) V ,$$

where: Attention(Q, K, V) is the attention function; Q∈ [symbol] ^{N×f} represents the query vectors of N Gaussian splats; K∈ [symbol] ^{T×f} is a matrix of key vectors; V∈ [symbol] ^{N×F} is a matrix of value vectors; f is a dimension of the key vectors and of the query vectors; and F is a dimension of feature vectors representing the N Gaussian splats.

Example 11. The method according to any of examples 1 to 10, wherein the information that is encoded comprises one or more of the query vectors, key vectors, and value vectors, but not all three of the query vectors, key vectors, and value vectors.

Example 12. The method according to any of examples 1 to 10, wherein the information that is encoded comprises one of QK^{T}, softmax(QK^{T}/\sqrt{f}) or (QK^{T}/\sqrt{f}), where Q represents the query vectors, K is a matrix of key vectors, and f is a dimension of the key vectors and of the query vectors.

Example 13. A method, comprising: in a decoding process for multimedia content carried in a bitstream, receiving the bitstream having encoded information comprising indications of one or more of query vectors, key vectors, and value vectors; performing decoding using an attention function with a set of key vectors and value vectors on the query vectors to form an output that is a feature representation of parameters of multiple Gaussian splats; and output information, based at least on the output, that is representative of the multimedia content.

Example 14. The method according to example 13, wherein performing decoding comprising: receiving in the encoded information compressed key-value vectors that have been compressed using a compression algorithm.

Example 15. The method according to example 14, wherein the performing decoding comprises: decoding indication identifying existence of compression of the key-value vectors and the corresponding compression algorithm used for the compression.

Example 16. The method according to example 15, wherein: the method further comprises decompressing the key-value vectors, to create decompressed key-value vectors, based on the corresponding compression algorithm used for the compression of the key-value vectors; and performing decoding comprises using the attention function with the set of key and value vectors on the query vectors to form the output, and the set of key and value vectors comprise the decompressed key-value vectors.

Example 17. The method according to any of examples 13 to 16, wherein performing decoding comprises: identifying key vectors, value vectors, and query vectors using a tag identifier that accompanies tensor data describing the key vectors, value vectors, and query vectors and dimensional information; and using the tag identifier and dimensional information to perform the decoding using the attention function.

Example 18. The method according to example 17, wherein the dimensional information comprises information of tensor data including a number of rows, a number of columns and row-wise and column-wise information related to the rows and columns.

Example 19. The method according to any of examples 13 to 18, wherein the decoding process is applied to two-dimensional video coding represented by at least some of the multiple Gaussian splats.

Example 20. The method according to any of examples 13 to 19, performing decoding using an attention function creates scores corresponding at least to the value vectors, and where the scores of value vectors are used to perform an approximation of the attention function, formed as a weighted sum of indexed value vectors.

Example 21. The method according to example 20, wherein the method further comprises caching the scores for the value vectors, and the scores used to perform the approximation of the attention function are the cached scores.

Example 22. The method according to any of examples 20 or 21, wherein the scores of value vectors used to perform the approximation of the attention function are value vectors that meet a threshold selecting these value vectors as achieving maximum attention scores out of a larger set of value vectors.

Example 23. The method according to any of examples 13 to 19, wherein the receiving further comprises receiving, from the bitstream, indication in the encoded information of one or both of scores or indices for the value vectors, and the performing decoding using the attention function performs an approximation of the attention function using the scores received via indication or via the indices in the bitstream to determine the scores.

Example 24. The method according to example 23, wherein the scores of value vectors used to perform the approximation of the attention function are value vectors that meet a threshold selecting these value vectors as achieving maximum attention scores out of a larger set of value vectors.

Example 25. The method according to any of examples 13 to 24, wherein the query vectors, key vectors, and value vectors corresponds to input of part or all of a field of view corresponding to the multimedia content, and the outputting information comprises outputting information to create the part or all of the field of view.

Example 26. The method according to example 25, wherein the information output for the field of view is expressed as Structure-from-Motion, a point cloud, spherical harmonics, or scaling coefficients, which represents information from the multiple Gaussian splats.

Example 27. The method according to any of examples 13 to 26, wherein the attention function comprises:

$$Attention ( Q , K , V ) = softmax ( \frac{{QK}^{T}}{\sqrt{f}} ) V ,$$

where: Attention(Q, K, V) is the attention function; Q∈ [symbol] ^{N×f} represents the query vectors of N Gaussian splats; K∈ [symbol] ^{T×f} is a matrix of key vectors; V∈ [symbol] ^{N×F} is a matrix of value vectors; f is a dimension of the key vectors and of the query vectors; and F is a dimension of feature vectors representing the N Gaussian splats.

Example 28. The method according to any of examples 13 to 27, wherein the encoded information comprises one or more of the query vectors, key vectors, and value vectors, but not all three of the query vectors, key vectors, and value vectors.

Example 29. The method according to any of examples 13 to 27, wherein the encoded information comprises one of QK^{T}, softmax(QK^{T}/\sqrt{f}) or (QK^{T}/\sqrt{f}), where Q represents the query vectors, K is a matrix of key vectors, and f is a dimension of the key vectors and of the query vectors.

Example 30. An apparatus, comprising means for: in an encoding process for multimedia content, forming vectors comprising query vectors, key vectors, and value vectors; running an attention function on the formed vectors to produce output, wherein the output is a representation of parameters of multiple Gaussian splats representing video of the multimedia content; and encoding information representing the multimedia content, the information comprising at least part of the formed vectors, and placing the information into a bitstream.

Example 31. The apparatus according to example 30, wherein the means are further configured for: compressing key-value vectors using a compression algorithm.

Example 32. The apparatus according to example 31, wherein the encoding information representing the multimedia content comprises: encoding indication identifying existence of compression of the key-value vectors and the corresponding compression algorithm used for the compression.

Example 33. The apparatus according to any of examples 30 to 32, wherein encoding comprises: identifying the key vectors, value vectors, and query vectors that will be encoded using a tag identifier that accompanies tensor data describing the key vectors, value vectors, and query vectors that will be encoded and dimensional information.

Example 34. The apparatus according to example 33, wherein the dimensional information comprises information of the tensor data including a number of rows, a number of columns and row-wise and column-wise information related to the rows and columns.

Example 35. The apparatus according to any of examples 30 to 34, wherein the encoding process is applied to two-dimensional video coding represented by at least some of the multiple Gaussian splats.

Example 36. The apparatus according to any of examples 30 to 35, wherein: running the attention function on the formed vectors creates scores corresponding at least to the value vectors; and the encoding information representing the multimedia content comprises encoding indication of scores for or cached indices of value vectors that achieve maximum attention scores out of a larger set of value vectors.

Example 37. The apparatus according to any of examples 30 to 36, wherein the forming vectors comprising query vectors, key vectors, and value vectors uses input of part or all of a field of view corresponding to the multimedia content.

Example 38. The apparatus according to example 37, wherein the input of the part or all of field of view is expressed as Structure-from-Motion, a point cloud, spherical harmonics, or scaling coefficients, which represents information from the multiple Gaussian splats.

Example 39. The apparatus according to any of examples 30 to 38, wherein the attention function comprises:

$$Attention ( Q , K , V ) = softmax ( \frac{{QK}^{T}}{\sqrt{f}} ) V ,$$

where: Attention(Q, K, V) is the attention function; Q∈ [symbol] ^{N×f} represents the query vectors of N Gaussian splats; K∈ [symbol] ^{T×f} is a matrix of key vectors; V∈ [symbol] ^{N×F} is a matrix of value vectors; f is a dimension of the key vectors and of the query vectors; and F is a dimension of feature vectors representing the N Gaussian splats.

Example 40. The apparatus according to any of examples 30 to 39, wherein the information that is encoded comprises one or more of the query vectors, key vectors, and value vectors, but not all three of the query vectors, key vectors, and value vectors.

Example 41. The apparatus according to any of examples 30 to 39, wherein the information that is encoded comprises one of QK^{T}, softmax(QK^{T}/\sqrt{f}) or (QK^{T}/\sqrt{f}), where Q represents the query vectors, K is a matrix of key vectors, and f is a dimension of the key vectors and of the query vectors.

Example 42. An apparatus, comprising means for: in a decoding process for multimedia content carried in a bitstream, receiving the bitstream having encoded information comprising indications of one or more of query vectors, key vectors, and value vectors; performing decoding using an attention function with a set of key vectors and value vectors on the query vectors to form an output that is a feature representation of parameters of multiple Gaussian splats; and output information, based at least on the output, that is representative of the multimedia content.

Example 43. The apparatus according to example 42, wherein performing decoding comprising: receiving in the encoded information compressed key-value vectors that have been compressed using a compression algorithm.

Example 44. The apparatus according to example 43, wherein the performing decoding comprises: decoding indication identifying existence of compression of the key-value vectors and the corresponding compression algorithm used for the compression.

Example 45. The apparatus according to example 44, wherein: the means are further configured for decompressing the key-value vectors, to create decompressed key-value vectors, based on the corresponding compression algorithm used for the compression of the key-value vectors; and performing decoding comprises using the attention function with the set of key and value vectors on the query vectors to form the output, and the set of key and value vectors comprise the decompressed key-value vectors.

Example 46. The apparatus according to any of examples 42 to 45, wherein performing decoding comprises: identifying key vectors, value vectors, and query vectors using a tag identifier that accompanies tensor data describing the key vectors, value vectors, and query vectors and dimensional information; and using the tag identifier and dimensional information to perform the decoding using the attention function.

Example 47. The apparatus according to example 46, wherein the dimensional information comprises information of tensor data including a number of rows, a number of columns and row-wise and column-wise information related to the rows and columns.

Example 48. The apparatus according to any of examples 42 to 47, wherein the decoding process is applied to two-dimensional video coding represented by at least some of the multiple Gaussian splats.

Example 49. The apparatus according to any of examples 42 to 48, performing decoding using an attention function creates scores corresponding at least to the value vectors, and where the scores of value vectors are used to perform an approximation of the attention function, formed as a weighted sum of indexed value vectors.

Example 50. The apparatus according to example 49, wherein the means are further configured for caching the scores for the value vectors, and the scores used to perform the approximation of the attention function are the cached scores.

Example 51. The apparatus according to any of examples 49 or 50, wherein the scores of value vectors used to perform the approximation of the attention function are value vectors that meet a threshold selecting these value vectors as achieving maximum attention scores out of a larger set of value vectors.

Example 52. The apparatus according to any of examples 42 to 48, wherein the receiving further comprises receiving, from the bitstream, indication in the encoded information of one or both of scores or indices for the value vectors, and the performing decoding using the attention function performs an approximation of the attention function using the scores received via indication or via the indices in the bitstream to determine the scores.

Example 53. The apparatus according to example 52, wherein the scores of value vectors used to perform the approximation of the attention function are value vectors that meet a threshold selecting these value vectors as achieving maximum attention scores out of a larger set of value vectors.

Example 54. The apparatus according to any of examples 42 to 53, wherein the query vectors, key vectors, and value vectors corresponds to input of part or all of a field of view corresponding to the multimedia content, and the outputting information comprises outputting information to create the part or all of the field of view.

Example 55. The apparatus according to example 54, wherein the information output for the field of view is expressed as Structure-from-Motion, a point cloud, spherical harmonics, or scaling coefficients, which represents information from the multiple Gaussian splats.

Example 56. The apparatus according to any of examples 42 to 55, wherein the attention function comprises:

$$Attention ( Q , K , V ) = softmax ( \frac{{QK}^{T}}{\sqrt{f}} ) V ,$$

where: Attention(Q, K, V) is the attention function; Q∈ [symbol] ^{N×f} represents the query vectors of N Gaussian splats; K∈ [symbol] ^{T×f} is a matrix of key vectors; V∈ [symbol] ^{N×F} is a matrix of value vectors; f is a dimension of the key vectors and of the query vectors; and F is a dimension of feature vectors representing the N Gaussian splats.

Example 57. The apparatus according to any of examples 42 to 56, wherein the encoded information comprises one or more of the query vectors, key vectors, and value vectors, but not all three of the query vectors, key vectors, and value vectors.

Example 58. The apparatus according to any of examples 42 to 56, wherein the encoded information comprises one of QKT, softmax(QK^{T}/\sqrt{f}) or (QK^{T}/\sqrt{f}), where Q represents the query vectors, K is a matrix of key vectors, and f is a dimension of the key vectors and of the query vectors.

Example 59. An apparatus, comprising: one or more processors; and one or more memories storing instructions that, when executed by the one or more processors, cause the apparatus at least to perform: in an encoding process for multimedia content, forming vectors comprising query vectors, key vectors, and value vectors; running an attention function on the formed vectors to produce output, wherein the output is a representation of parameters of multiple Gaussian splats representing video of the multimedia content; and encoding information representing the multimedia content, the information comprising at least part of the formed vectors, and placing the information into a bitstream.

Example 60. The apparatus according to example 59, wherein the one or more memories further store instructions that, when executed by the one or more processors, cause the apparatus at least to perform: compressing key-value vectors using a compression algorithm.

Example 61. The apparatus according to example 60, wherein the encoding information representing the multimedia content comprises: encoding indication identifying existence of compression of the key-value vectors and the corresponding compression algorithm used for the compression.

Example 62. The apparatus according to any of examples 59 to 61, wherein encoding comprises: identifying the key vectors, value vectors, and query vectors that will be encoded using a tag identifier that accompanies tensor data describing the key vectors, value vectors, and query vectors that will be encoded and dimensional information.

Example 63. The apparatus according to example 62, wherein the dimensional information comprises information of the tensor data including a number of rows, a number of columns and row-wise and column-wise information related to the rows and columns.

Example 64. The apparatus according to any of examples 59 to 63, wherein the encoding process is applied to two-dimensional video coding represented by at least some of the multiple Gaussian splats.

Example 65. The apparatus according to any of examples 59 to 64, wherein: running the attention function on the formed vectors creates scores corresponding at least to the value vectors; and the encoding information representing the multimedia content comprises encoding indication of scores for or cached indices of value vectors that achieve maximum attention scores out of a larger set of value vectors.

Example 66. The apparatus according to any of examples 59 to 65, wherein the forming vectors comprising query vectors, key vectors, and value vectors uses input of part or all of a field of view corresponding to the multimedia content.

Example 67. The apparatus according to example 66, wherein the input of the part or all of field of view is expressed as Structure-from-Motion, a point cloud, spherical harmonics, or scaling coefficients, which represents information from the multiple Gaussian splats.

Example 68. The apparatus according to any of examples 59 to 67, wherein the attention function comprises:

$$Attention ( Q , K , V ) = softmax ( \frac{{QK}^{T}}{\sqrt{f}} ) V ,$$

where: Attention(Q, K, V) is the attention function; Q∈ [symbol] ^{N×f} represents the query vectors of N Gaussian splats; K∈ [symbol] ^{T×f} is a matrix of key vectors; V∈ [symbol] ^{N×F} is a matrix of value vectors; f is a dimension of the key vectors and of the query vectors; and F is a dimension of feature vectors representing the N Gaussian splats.

Example 69. The apparatus according to any of examples 59 to 68, wherein the information that is encoded comprises one or more of the query vectors, key vectors, and value vectors, but not all three of the query vectors, key vectors, and value vectors.

Example 70. The apparatus according to any of examples 59 to 68, wherein the information that is encoded comprises one of QK^{T}, softmax(QK^{T}/\sqrt{f}) or (QK^{T}/\sqrt{f}), where Q represents the query vectors, K is a matrix of key vectors, and f is a dimension of the key vectors and of the query vectors.

Example 71. An apparatus, comprising: one or more processors; and one or more memories storing instructions that, when executed by the one or more processors, cause the apparatus at least to perform: in a decoding process for multimedia content carried in a bitstream, receiving the bitstream having encoded information comprising indications of one or more of query vectors, key vectors, and value vectors; performing decoding using an attention function with a set of key vectors and value vectors on the query vectors to form an output that is a feature representation of parameters of multiple Gaussian splats; and output information, based at least on the output, that is representative of the multimedia content.

Example 72. The apparatus according to example 71, wherein performing decoding comprising: receiving in the encoded information compressed key-value vectors that have been compressed using a compression algorithm.

Example 73. The apparatus according to example 72, wherein the performing decoding comprises: decoding indication identifying existence of compression of the key-value vectors and the corresponding compression algorithm used for the compression.

Example 74. The apparatus according to example 73, wherein: the one or more memories further store instructions that, when executed by the one or more processors, cause the apparatus at least to perform decompressing the key-value vectors, to create decompressed key-value vectors, based on the corresponding compression algorithm used for the compression of the key-value vectors; and performing decoding comprises using the attention function with the set of key and value vectors on the query vectors to form the output, and the set of key and value vectors comprise the decompressed key-value vectors.

Example 75. The apparatus according to any of examples 71 to 74, wherein performing decoding comprises: identifying key vectors, value vectors, and query vectors using a tag identifier that accompanies tensor data describing the key vectors, value vectors, and query vectors and dimensional information; and using the tag identifier and dimensional information to perform the decoding using the attention function.

Example 76. The apparatus according to example 75, wherein the dimensional information comprises information of tensor data including a number of rows, a number of columns and row-wise and column-wise information related to the rows and columns.

Example 77. The apparatus according to any of examples 71 to 76, wherein the decoding process is applied to two-dimensional video coding represented by at least some of the multiple Gaussian splats.

Example 78. The apparatus according to any of examples 71 to 77, performing decoding using an attention function creates scores corresponding at least to the value vectors, and where the scores of value vectors are used to perform an approximation of the attention function, formed as a weighted sum of indexed value vectors.

Example 79. The apparatus according to example 78, wherein the one or more memories further store instructions that, when executed by the one or more processors, cause the apparatus at least to perform caching the scores for the value vectors, and the scores used to perform the approximation of the attention function are the cached scores.

Example 80. The apparatus according to any of examples 78 or 79, wherein the scores of value vectors used to perform the approximation of the attention function are value vectors that meet a threshold selecting these value vectors as achieving maximum attention scores out of a larger set of value vectors.

Example 81. The apparatus according to any of examples 71 to 77, wherein the receiving further comprises receiving, from the bitstream, indication in the encoded information of one or both of scores or indices for the value vectors, and the performing decoding using the attention function performs an approximation of the attention function using the scores received via indication or via the indices in the bitstream to determine the scores.

Example 82.The apparatus according to example 81, wherein the scores of value vectors used to perform the approximation of the attention function are value vectors that meet a threshold selecting these value vectors as achieving maximum attention scores out of a larger set of value vectors.

Example 83. The apparatus according to any of examples 71 to 82, wherein the query vectors, key vectors, and value vectors corresponds to input of part or all of a field of view corresponding to the multimedia content, and the outputting information comprises outputting information to create the part or all of the field of view.

Example 84. The apparatus according to example 83, wherein the information output for the field of view is expressed as Structure-from-Motion, a point cloud, spherical harmonics, or scaling coefficients, which represents information from the multiple Gaussian splats.

Example 85. The apparatus according to any of examples 71 to 84, wherein the attention function comprises:

$$Attention ( Q , K , V ) = softmax ( \frac{{QK}^{T}}{\sqrt{f}} ) V ,$$

where: Attention(Q, K, V) is the attention function; Q∈ [symbol] ^{N×f} represents the query vectors of N Gaussian splats; K∈ [symbol] ^{T×f} is a matrix of key vectors; V∈ [symbol] ^{N×F} is a matrix of value vectors; f is a dimension of the key vectors and of the query vectors; and F is a dimension of feature vectors representing the N Gaussian splats.

Example 86. The apparatus according to any of examples 71 to 85, wherein the encoded information comprises one or more of the query vectors, key vectors, and value vectors, but not all three of the query vectors, key vectors, and value vectors.

Example 87. The apparatus according to any of examples 71 to 85, wherein the encoded information comprises one of QK^{T}, softmax(QK^{T}/\sqrt{f}) or (QK^{T}/\sqrt{f}), where Q represents the query vectors, K is a matrix of key vectors, and f is a dimension of the key vectors and of the query vectors.

Example 88. A computer program, comprising instructions which, when the program is executed by an apparatus, cause the apparatus to carry out the methods of any of examples 1 to 29.

Example 89. The computer program according to example 88, wherein the computer program is a computer program product comprising a computer-readable medium bearing the instructions embodied therein for use with the apparatus.

Example 90. The computer program according to example 88, wherein the computer program is directly loadable into an internal memory of the apparatus.

As used in this application, the term “circuitry” may refer to one or more or all of the following:
(a) hardware-only circuit implementations (such as implementations in only analog and/or digital circuitry) and
(b) combinations of hardware circuits and software, such as (as applicable): (i) a combination of analog and/or digital hardware circuit(s) with software/firmware and (ii) any portions of hardware processor(s) (including digital signal processor(s)) with software, and memory (ies) that work together to cause an apparatus, such as a mobile phone or server, to perform various functions) and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

Embodiments herein may be implemented in software (executed by one or more processors), hardware (e.g., an application specific integrated circuit), or a combination of software and hardware. In an example embodiment, the software (e.g., application logic, an instruction set) is maintained on any one of various conventional computer-readable media. In the context of this document, a “computer-readable medium” may be any media or means that can contain, store, communicate, propagate or transport the instructions for use by or in connection with an instruction execution system, apparatus, or device, such as a computer, with one example of a computer described and depicted, e.g., in FIG. 4. A computer-readable medium may comprise a computer-readable storage medium (e.g., memories 425 or other device) that may be any media or means that can contain, store, and/or transport the instructions for use by or in connection with an instruction execution system, apparatus, or device, such as a computer. A computer-readable storage medium does not comprise propagating signals, and therefore may be considered to be non-transitory. The term “non-transitory”, as used herein, is a limitation of the medium itself (i.e., tangible, not a signal) as opposed to a limitation on data storage persistency (e.g., RAM, random access memory, versus ROM, read-only memory).

If desired, the different functions discussed herein may be performed in a different order and/or concurrently with each other. Furthermore, if desired, one or more of the above-described functions may be optional or may be combined.

Although various aspects of the invention are set out in the independent claims, other aspects of the invention comprise other combinations of features from the described embodiments and/or the dependent claims with the features of the independent claims, and not solely the combinations explicitly set out in the claims.

It is also noted herein that while the above describes example embodiments of the invention, these descriptions should not be viewed in a limiting sense. Rather, there are several variations and modifications which may be made without departing from the scope of the present invention as defined in the appended claims.

The following abbreviations that may be found in the specification and/or the drawing figures are defined as follows:
2D two dimensional
3D three dimensional
3DGS three-dimensional Gaussian splatting
CTU coding tree unit
CU coding unit
FoV field of view
INR implicit neural representation
LiDAR light detection and ranging, or laser imaging, detection, and ranging
NN neural network
PSNR Peak signal-to-noise ratio
rgb or RGB red, green, blue
SfM Structure-from-Motion
SH spherical harmonic

What is claimed is:

1. A method, comprising:
in an encoding process for multimedia content, forming vectors comprising query vectors, key vectors, and value vectors;
running an attention function on the formed vectors to produce output, wherein the output is a representation of parameters of multiple Gaussian splats representing video of the multimedia content; and
encoding information representing the multimedia content, the information comprising at least part of the formed vectors, and placing the information into a bitstream.

2. A method, comprising:
in a decoding process for multimedia content carried in a bitstream, receiving the bitstream having encoded information comprising indications of one or more of query vectors, key vectors, and value vectors;
performing decoding using an attention function with a set of key vectors and value vectors on the query vectors to form an output that is a feature representation of parameters of multiple Gaussian splats; and
outputting information, based at least on the output, that is representative of the multimedia content.

3. An apparatus, comprising:
one or more processors; and
one or more memories storing instructions that, when executed by the one or more processors, cause the apparatus at least to perform:
in an encoding process for multimedia content, forming vectors comprising query vectors, key vectors, and value vectors;
running an attention function on the formed vectors to produce output, wherein the output is a representation of parameters of multiple Gaussian splats representing video of the multimedia content; and
encoding information representing the multimedia content, the information comprising at least part of the formed vectors, and placing the information into a bitstream.

4. The apparatus according to claim 3, wherein the one or more memories further store instructions that, when executed by the one or more processors, cause the apparatus at least to perform:
compressing key-value vectors using a compression algorithm; and
encoding indication identifying existence of compression of the key-value vectors and the corresponding compression algorithm used for the compression.

5. The apparatus according to claim 3, wherein encoding comprises:
identifying the key vectors, value vectors, and query vectors that will be encoded using a tag identifier that accompanies tensor data describing the key vectors, value vectors, and query vectors that will be encoded and dimensional information.

6. The apparatus according to claim 3, wherein:
running the attention function on the formed vectors creates scores corresponding at least to the value vectors; and
the encoding information representing the multimedia content comprises encoding indication of scores for or cached indices of value vectors that achieve maximum attention scores out of a larger set of value vectors.

7. The apparatus according to claim 3, wherein the information that is encoded comprises one or more of the query vectors, key vectors, and value vectors, but not all three of the query vectors, key vectors, and value vectors.

8. An apparatus, comprising:
one or more processors; and
one or more memories storing instructions that, when executed by the one or more processors, cause the apparatus at least to perform:
in a decoding process for multimedia content carried in a bitstream, receiving the bitstream having encoded information comprising indications of one or more of query vectors, key vectors, and value vectors;
performing decoding using an attention function with a set of key vectors and value vectors on the query vectors to form an output that is a feature representation of parameters of multiple Gaussian splats; and
outputting information, based at least on the output, that is representative of the multimedia content.

9. The apparatus according to claim 8, wherein performing decoding comprising:
receiving in the encoded information key-value vectors that have been compressed using a compression algorithm; and
decoding indication identifying existence of compression of the key-value vectors and the corresponding compression algorithm used for the compression.

10. The apparatus according to claim 9, wherein:
the one or more memories further store instructions that, when executed by the one or more processors, cause the apparatus at least to perform decompressing the key-value vectors, to create decompressed key-value vectors, based on the corresponding compression algorithm used for the compression of the key-value vectors; and
performing decoding comprises using the attention function with the set of key and value vectors on the query vectors to form the output, and the set of key and value vectors comprise the decompressed key-value vectors.

11. The apparatus according to claim 8, wherein performing decoding comprises:
identifying key vectors, value vectors, and query vectors using a tag identifier that accompanies tensor data describing the key vectors, value vectors, and query vectors and dimensional information; and
using the tag identifier and dimensional information to perform the decoding using the attention function.

12. The apparatus according to claim 11, wherein the dimensional information comprises information of tensor data including a number of rows, a number of columns and row-wise and column-wise information related to the rows and columns.

13. The apparatus according to claim 8, wherein the decoding process is applied to two-dimensional video coding represented by at least some of the multiple Gaussian splats.

14. The apparatus according to claim 8, performing decoding using an attention function creates scores corresponding at least to the value vectors, and where the scores of value vectors are used to perform an approximation of the attention function, formed as a weighted sum of indexed value vectors.

15. The apparatus according to claim 14, wherein the one or more memories further store instructions that, when executed by the one or more processors, cause the apparatus at least to perform caching the scores for the value vectors, and the scores used to perform the approximation of the attention function are the cached scores.

16. The apparatus according to claim 14, wherein the scores of value vectors used to perform the approximation of the attention function are value vectors that meet a threshold selecting these value vectors as achieving maximum attention scores out of a larger set of value vectors.

17. The apparatus according to claim 8, wherein the receiving further comprises receiving, from the bitstream, indication in the encoded information of one or both of scores or indices for the value vectors, and the performing decoding using the attention function performs an approximation of the attention function using the scores received via indication or via the indices in the bitstream to determine the scores.

18. The apparatus according to claim 17, wherein the scores of value vectors used to perform the approximation of the attention function are value vectors that meet a threshold selecting these value vectors as achieving maximum attention scores out of a larger set of value vectors.

19. The apparatus according to claim 8, wherein the attention function comprises:
$$Attention ( Q , K , V ) = softmax ( \frac{{QK}^{T}}{\sqrt{f}} ) V ,$$
where:
Attention(Q, K,V) is the attention function;
Q∈ [symbol] ^{N×f} represents the query vectors of N Gaussian splats;
K∈ [symbol] ^{T×f} is a matrix of key vectors;
V∈ [symbol] ^{N×F} is a matrix of value vectors;
f is a dimension of the key vectors and of the query vectors; and
F is a dimension of feature vectors representing the N Gaussian splats.

20. The apparatus according to claim 8, wherein the encoded information comprises one or more of the query vectors, key vectors, and value vectors, but not all three of the query vectors, key vectors, and value vectors.

21. The apparatus according to claim 8, wherein the encoded information comprises one of QK^{T}, softmax(QK^{T}/\sqrt{f}) or (QK^{T}/\sqrt{f}), where Q represents the query vectors, K is a matrix of key vectors, and f is a dimension of the key vectors and of the query vectors.
